(19) United States
(12) Patent Application Publication
(10) Pub. No.: US 2014/0332505 A1
(43) Pub. Date: Nov. 13, 2014

(54) METHOD OF MANUFACTURING TRACK SHOE

(71) Applicant: Caterpillar Inc., Peoria, IL (US)

(72) Inventor: Paul Prest, Peoria, IL (US)

(73) Assignee: Caterpillar Inc., Peoria, IL (US)

(21) Appl. No.: 14/339,796

(22) Filed: Jul. 24, 2014

(51) Int. Cl. B23K 28/02; B23K 26/38; B23K 10/00

(52) U.S. Cl. CPC B23K 28/02; B23K 10/00; B23K 26/38
USPC 219/121.44

(57) ABSTRACT

A method of manufacturing an undercarriage track shoe is provided. The method includes positioning a track shoe longbar at a workstation. The track shoe longbar has a sectional profile for a plurality of track shoes thereon. The method also includes engaging one end of the track shoe longbar in a first chuck and a second end of the track shoe longbar in a second chuck. The method also includes cutting at least one of a hole and a notch into the track shoe longbar using a laser cutter. The method includes cutting a single track shoe from the track shoe longbar using a plasma cutter.

### TECHNICAL FIELD

The present disclosure relates to a track shoe for an undercarriage assembly, and more particularly to a method for manufacturing the track shoe.

### BACKGROUND

Track type mobile machines include tracks that are provided on opposing sides of the machine. The tracks generally include ground engaging elements known as track shoes that contact a work surface. The geometry of the track shoes is such that the track shoes may be connected to other elements, for example, track links that are connected to one another in series to form a track chain. Accordingly, the track shoes may include, for example, holes, notches, trap holes, and the like thereon. During manufacturing of the track shoes, these holes, notches and trap holes may be cut from a track shoe longbar at a workstation. The track shoe longbar may then be sent to another workstation for cutting each of the track shoes from the track shoe longbar. In some situations, these workstations may be located at different places. Transportation of the track shoe longbar from one workstation to another during the manufacturing of the track shoe may increase the time and costs associated with the manufacturing of the track shoes. This may impact an overall efficiency in the production of the track shoes.

U.S. Pat. No. 7,960,669 describes a hybrid thermal cutting apparatus that has a laser head and a plasma torch, both of which can be controlled independently, and can perform both laser processing and plasma processing. A large number of cutting lines for cutting out various types of manufactured products from plate materials are classified into a laser cutting type and a plasma cutting type, according to the cutting length, whether they are the external periphery of manufactured products or apertures, the size of the manufactured products or the apertures, the required process accuracy, the plate thickness, or the like. The lines of the laser cutting type are cut by laser processing, while the lines of the plasma cutting type are cut by plasma processing.

### SUMMARY OF THE DISCLOSURE

In one aspect of the present disclosure, a method of manufacturing an undercarriage track shoe is provided. The method includes positioning a track shoe longbar at a workstation. The track shoe longbar has a sectional profile for a plurality of track shoes thereon. Further, the sectional profile of the track shoe longbar includes a substantially planar base portion and at least one grouser extending from the base portion in a direction substantially perpendicular to the base portion. The method also includes engaging one end of the track shoe longbar in a first chuck and a second end of the track shoe longbar in a second chuck. At least one of the first chuck and the second chuck is capable of movement in a first direction along a longitudinal axis. Further, the first chuck and the second chuck are also rotatable about the longitudinal axis, wherein the longitudinal axis is generally parallel to the first direction. The method also includes cutting at least one of a hole and a notch into the track shoe longbar using a laser cutter. The laser cutter may be moved in at least one of the first direction, a second direction, and a third direction. Further, the second direction is generally perpendicular and coplanar with the first direction, and the third direction is generally perpendicular to the first and second directions. The method includes cutting a single track shoe from the track shoe longbar using a plasma cutter. Also, at least one of the first chuck and the second chuck may be rotated relative to the plasma cutter during cutting. Further, the plasma cutter may be movable in at least one of the first direction, the second direction, and the third direction.

Other features and aspects of this disclosure will be apparent from the following description and the accompanying drawings.

### BRIEF DESCRIPTION OF THE DRAWINGS

FIG. 1 is a perspective view of an exemplary system for manufacturing a track shoe;

FIG. 2 is a block diagram of the system of FIG. 1;

FIG. 3 is a perspective view of the track shoe; and

FIG. 4 is a schematic representation of a method of manufacturing the track shoe.

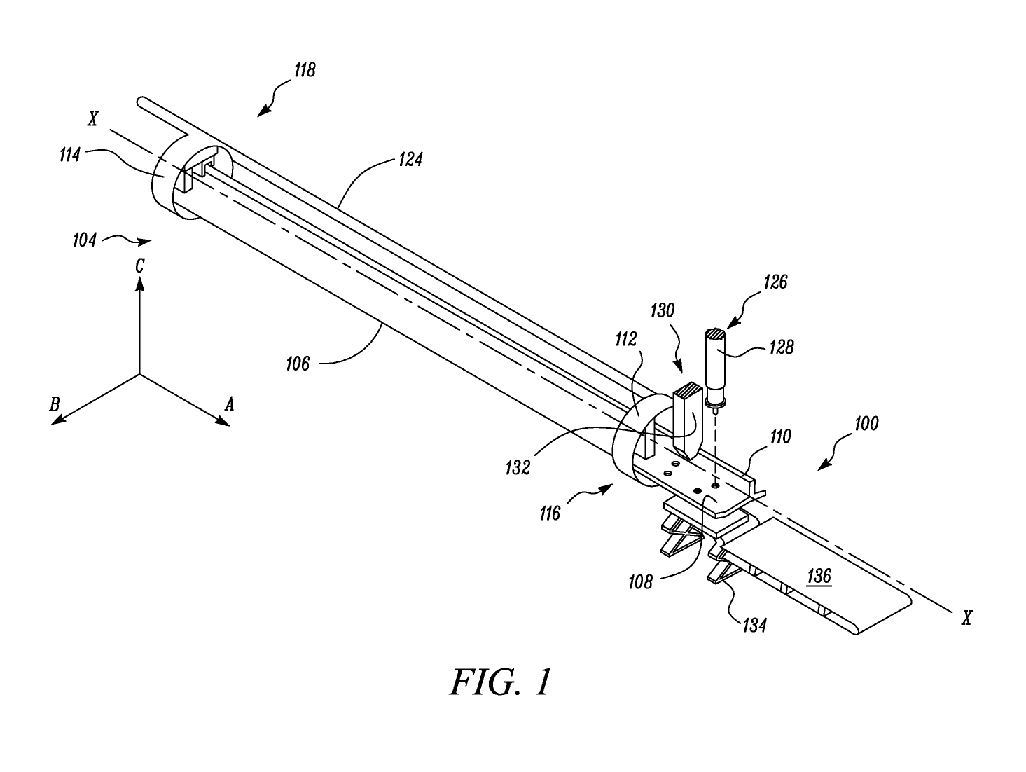

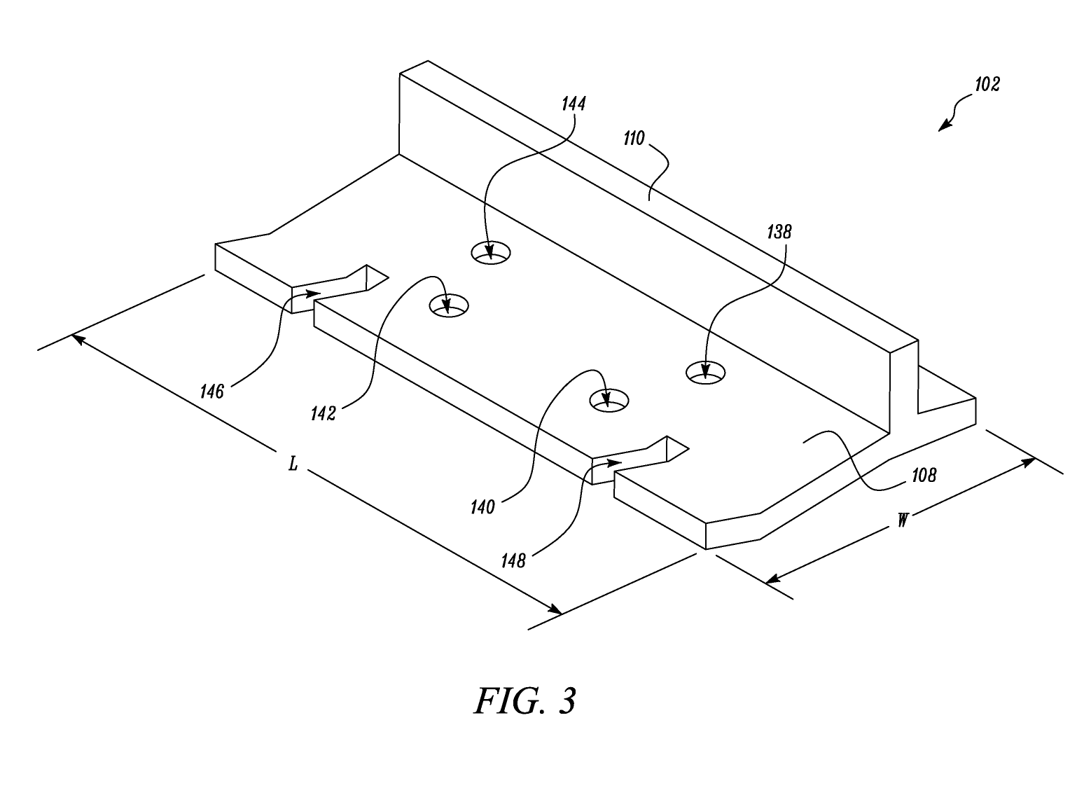

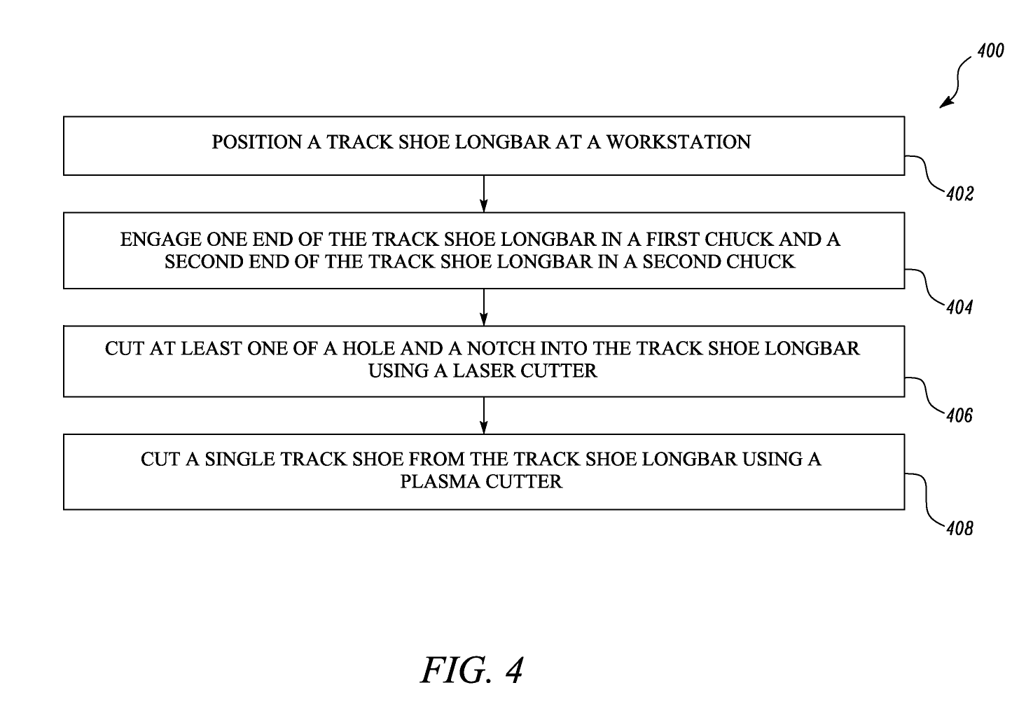

### DETAILED DESCRIPTION

Wherever possible, the same reference numbers will be used throughout the drawings to refer to the same or the like parts. FIG. 1 is a perspective view of a workstation 100 for manufacturing an undercarriage track shoe 102 (see FIG. 3). The track shoe 102 may form a part of an undercarriage track system associated with a machine (not shown). The workstation 100 includes a cutting system 104. One or more operations may be performed by the cutting system 104 on a track shoe longbar 106 for production and manufacturing of the track shoe 102 at the workstation 100.

The track shoe longbar 106 disclosed herein has a sectional profile for a plurality of track shoes thereon. The cutting system 104 may be configured to form or provide various geometries, such as, a hole, a notch, or any similar opening on the track shoe longbar 106. The cutting system 104 may also be configured to cut the single track shoe 102 from the track shoe longbar 106. As shown in the accompanying figures, the track shoe longbar 106 may include a base portion 108. The base portion 108 is substantially planar. The track shoe longbar 106 also includes at least one grouser 110 extending in a direction substantially perpendicular to the base portion 108.

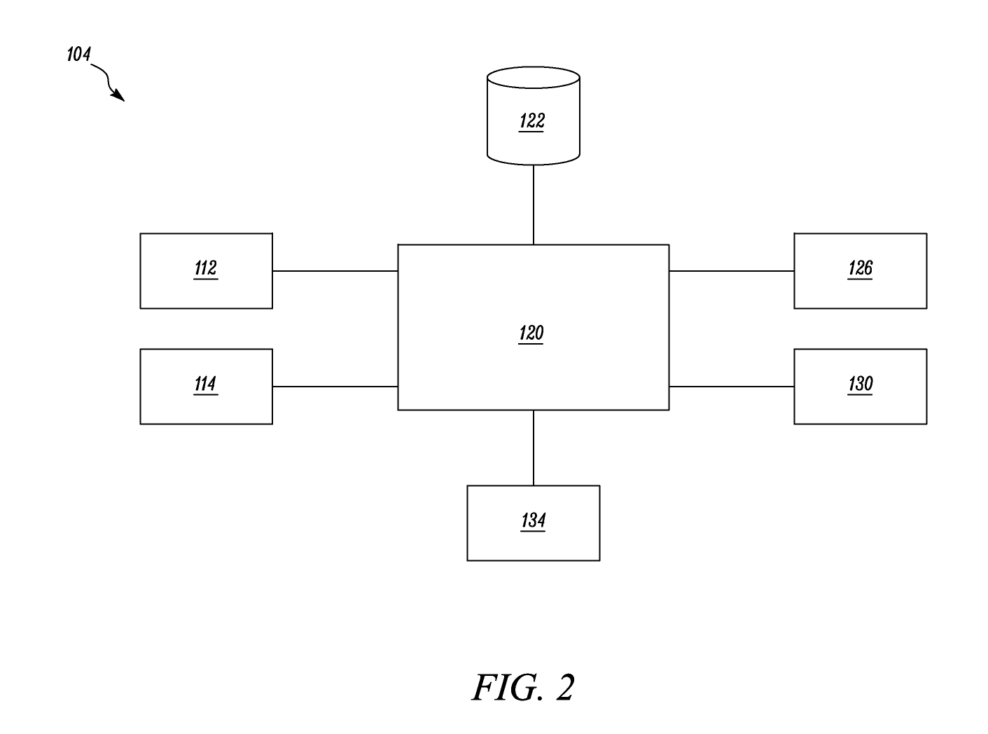

Referring to FIGS. 1 and 2, the cutting system 104 includes a first chuck 112 and a second chuck 114. The second chuck 114 is longitudinally spaced apart from the first chuck 112. The first and second chucks 112, 114 define a longitudinal axis X-X. Further, the first and second chucks 112, 114 may have similar design and dimensions. The first and second chucks 112, 114 described herein have a circular profile. In the illustrated embodiment, the first chuck 112 is positioned at a front end 116 of the cutting system 104. Whereas, the second chuck 114 is positioned at a rear end 118 of the cutting system 104. Alternatively, in one embodiment, the first chuck 112 may be provided at the rear end 118 of the cutting system 104, whereas the second chuck 114 may be positioned at the frond end 116 of the cutting system 104.

During manufacture, the track shoe longbar 106 may be held between the first and second chucks 112, 114. More specifically, one end of the track shoe longbar 106 is engaged with the first chuck 112, whereas a second opposite end of the track shoe longbar 106 is engaged with the second chuck 114. The first and second chucks 112, 114 are designed such that, during manufacturing, the track shoe longbar 106 may be held securely by the first and second chucks 112, 114 so that there is minimum or no movement of the track shoe longbar 106.

Referring to FIG. 2, the first and second chucks 112, 114 are communicably coupled to a controller 120. The controller 120 may embody a single microprocessor or multiple microprocessors. Numerous commercially available microprocessors may be configured to perform the functions of the controller 120. It should be appreciated that the controller 120 may readily embody a general machine microprocessor capable of controlling numerous machine functions. A person of ordinary skill in the art will appreciate that the controller 120 may additionally include other components and may also perform other functionality not described herein. It should be understood that the embodiments and the connections explained herein are merely on an exemplary basis and do not limit the scope and spirit of the disclosure.

Further, the controller 120 is communicably coupled to a database 122. The database 122 may store information related to various track shoe designs. For example, each track shoe design may be identified by a unique part number. The database 122 may be configured to store all the unique part numbers and relevant design data associated therewith, such as, for example, track shoe length, number of holes or notches, positioning of the holes or notches, size, and other dimensional data. In one example, when an operator of the cutting system 104 inputs a specific part number, the controller 120 may search the database 122 and retrieve the design data related to the track shoe design of the requested part number.

One of ordinary skill in the art will appreciate that the database 122 may be any conventional database known in the art. Moreover, the database 122 may be capable of storing and/or modifying pre-stored data as per operational and design needs. In one embodiment, the database 122 may be extrinsic to the cutting system 104 and located at a remote location away from the cutting system 104. Alternatively, the database 122 may be intrinsic to the cutting system 104.

Based on a signal received from the controller 120, the second chuck 114 of the cutting system 104 is capable of movement in a first direction “A”. It should be noted that the first direction “A” disclosed herein is substantially parallel to the longitudinal axis X-X. The second chuck 114 may move along the first direction “A” in a forward or reverse manner based on requirement. For example, in a situation wherein the track shoe longbar 106 needs to be advanced from the first chuck 112, the controller 120 may send signals to the second chuck 114 to move in the first direction “A”. Alternatively, in one embodiment, the first chuck 112 may move in the first direction “A”.

The movement of the second chuck 114 in the first direction “A” is along a slider attachment 124. The slider attachment 124 provides support to the second chuck 114, during the movement. One end of the slider attachment 124 may be fixedly attached to the first chuck 112 to allow the second chuck 114 to move towards the first chuck 112. On receiving signals from the controller 120, the first and second chucks 112, 114 are capable of rotating about the longitudinal axis X-X. Based on the operation being performed, the first and second chucks 112, 114 may be rotated in unison, thereby causing a rotation of the track shoe longbar 106 about the longitudinal axis X-X.

As shown in FIGS. 1 and 2, the cutting system 104 includes a laser cutter 126 provided at the workstation 100. The laser cutter 126 may be communicably coupled to the controller 120. The laser cutter 126 may include a laser head 128 and laser optics (not shown). The laser cutter 126 may use a laser beam produced or projected from the laser head 128 to cut a hole, a notch, or any other recess or opening in the track shoe longbar 106. The laser cutter 126 may use a known laser beam, for example, a CO2 laser, neodymium (Nd) or neodymium yttrium-aluminium-garnet (Nd-YAG) laser for cutting purposes. During the laser cutting operation, the laser head 128 of the laser cutter 126 may receive signals from the controller 120 and may move in the first direction “A”, a second direction “B”, and a third direction “C”. It should be noted that the second direction “B” is substantially perpendicular to and coplanar with the first direction “A”. Further, the third direction “C” may be generally perpendicular to the first and second directions “A”, “B”. The movement of the laser cutter 126 may be in a forward or reverse manner in the said directions “A”, “B”, and “C”.

As shown in the accompanying figures, the cutting system 104 further includes a plasma cutter 130. The plasma cutter 130 is configured to cut the single track shoe 102 of a particular length from the track shoe longbar 106. The plasma cutter 130 may be communicably coupled to the controller 120. The plasma cutter 130 may include a plasma torch 132. During the plasma cutting operation, the plasma torch 132 may impinge a plasma arc on to the track shoe longbar 106 in order to cut the track shoe 102 therefrom. Based on the signals received from the controller 120, the plasma torch 132 of the plasma cutter 130 may be capable of movement in the first direction “A”, the second direction “B”, and/or the third direction “C”.

The cutting system 104 may also include a lift table 134. The lift table 134 may be embodied as a scissor-type lift table. The lift table 134 may be configured to support the track shoe longbar 106 during the plasma cutting operation of the track shoe 102. It should be noted that the lift table 134 supports the track shoe longbar 106 during the plasma cutting operation and may be in a lowered position during the laser cutting operation. In one embodiment, the lift table 134 may be communicably coupled to the controller 120. Based on the signals received from the controller 120, the lift table 134 may be raised or lowered. Alternatively, the lift table 134 may be raised or lowered manually based on the operation being performed. The cutting system 104 may include a conveyor 136. The conveyor 136 may be positioned adjacent to the lift table 134. The conveyor 136 may be configured to receive the track shoe 102, and transport the track shoe 102 to another location for subsequent operations.

FIG. 3 is a perspective view of the exemplary track shoe 102, manufactured by the cutting system 104. The track shoe 102 disclosed herein includes a plurality of through holes. In one example, the through holes may be configured to connect the track shoe 102 with a corresponding track link (not shown). In the illustrated embodiment, the track shoe 102 includes four holes, namely a first hole 138, a second hole 140, a third hole 142, and a fourth hole 144 provided by the laser cutter 126. The track shoe 102 may further include a pair of notches 146, 148 provided by the laser cutter 126. The notches 146, 148 may be U-shaped, substantially rectangular, or substantially square shaped. The notches 146, 148 may receive a portion of a track chain (not shown) of the undercarriage track system, during an operation of tracks (not shown). The notches 146, 148 may also provide a passage for a removal of dirt, mud, stones, water, and the like, during operation of the tracks. It should be noted that the number of holes and notches disclosed herein is exemplary; the track shoe 102 may include any number of holes and/or notches based on system requirements.

An exemplary process of manufacture for the track shoe 102 will now be described in detail. The controller 120 may actuate and position the laser head 128 of the laser cutter 126 over the track shoe longbar 106. In an exemplary embodiment, the laser head 128 of the laser cutter 126 may cut the first hole 138 (see FIG. 3) in the track shoe longbar 106. The controller 120 may then send signals to the laser cutter 126, in order to move the laser head 128 in the second direction “B” by a predetermined distance to cut the second hole 140 (see FIG. 3). Further, the laser head 128 of the laser cutter 126 may move in any of the first, second, and/or third directions “A”, “B”, and “C”, in order to cut the third and fourth holes 142, 144.

The laser cutter 126 may cut the notches 146, 148 in a manner similar to the cutting of the holes 138, 140, 142, 144 described above. It should be noted that the second chuck 114 is configured to move the track shoe longbar 106 in the first direction “A” once all the holes 138, 140, 142, 144 and the notches 146, 148 have been cut.

After cutting of the holes 138, 140, 142, 144 and the notches 146, 148, the controller 120 may switch off the laser cutter 126. The controller 120 may then actuate the plasma cutter 130. At this time, the controller 120 may also send control signals to the lift table 134, such that the lift table 134 may raise and support the track shoe longbar 106 thereon. During the track shoe cutting operation, the plasma torch 132 of the plasma cutter 130 may be moved over a width “W” of the track shoe longbar 106 in order to cut the track shoe 102 of a length “L”. The length “L” of the track shoe 102 may vary for different designs of the track shoes, and may be retrieved by the controller 120 from the database 122.

Further, before initiating the plasma cutting operation, the plasma cutter 130 may be positioned, with respect to the track shoe longbar 106. It should be noted that the plasma torch 132 may be brought to the required position by moving the plasma torch 132 along the first, second and third directions “A”, “B”, and “C” respectively, or by moving the second chuck 114 along the first direction “A”. Further, after the positioning of the plasma torch 132, the controller 120 may actuate the plasma torch 132 of the plasma cutter 130 to cut the track shoe 102 of the length “L”.

As discussed earlier, the track shoe longbar 106 includes a grouser 110 (see FIGS. 1 and 3). The grouser 110 has a thickness which is greater than a thickness of the base portion 108 (see FIGS. 1 and 3). Accordingly, the controller 120 may send control signals to rotate the first and second chucks 112, 114, such that the first and second chucks 112, 114 in turn rotate the track shoe longbar 106. This allows the plasma cutter 130 to be positioned such that the plasma cutter 130 is at a location at which the thickness of the track shoe longbar 106 provides for ease in cutting. In one example, the first and second chucks 112, 114 may be rotated in a clockwise direction about the longitudinal axis X-X. Also, in some situations, after rotation of the track shoe longbar 106, the track shoe longbar 106 may interfere with the plasma torch 132 of the plasma cutter 130. Accordingly, the controller 120 may send signals to the plasma cutter 130, in order to move the plasma torch 132 in the third direction “C” in an upward manner or in a downward manner as required.

The rotation of the track shoe longbar 106 and the movement of the plasma torch 132 together provide an efficient cutting of the track shoe longbar 106 across a width of the grouser 110. Further, after cutting of the track shoe longbar 106 across the grouser 110, the first and second chucks 112, 114 may be rotated in an anti-clockwise direction about the longitudinal axis X-X, and also the plasma torch 132 may be repositioned as per the requirement. The single track shoe 102 may be transported to a subsequent workstation by the conveyor 136 for further operations thereon. One of ordinary skill in the art will appreciate that the track shoe design and the process described herein is exemplary and does not limit the scope of the present disclosure.

### INDUSTRIAL APPLICABILITY

Manufacturing of the track shoes of the undercarriage track system generally includes the step of shot blasting the longbar. The track shoe longbar is then transported to a workstation for the purpose of providing various geometries on the track shoe longbar. Further, the track shoe longbars are sent to another workstation, where the individual track shoes are cut-off from the track shoe longbar.

It may be difficult to handle the track shoe longbars during transportation between various workstations. Also, the transportation may increase the manufacturing time of the track shoes and thereby also cause an increase in the cost associated with the manufacturing of the track shoes. Further, more than one person may be required for the transportation and manufacturing of the track shoes.

The present disclosure relates to a method 400 of manufacturing the undercarriage track shoe 102 using the laser cutter 126 and the plasma cutter 130 provided at the workstation 100. Thus, by performing the cutting operations at the workstation 100, transportation overheads may be avoided or reduced. At step 402, the track shoe longbar 106 is positioned at the workstation 100. At step 404, the one end of the track shoe longbar 106 is engaged in the first chuck 112 and the second end of the track shoe longbar 106 is engaged in the second chuck 114.

At step 406, the holes 138, 140, 142, 144 and the notches 146, 148 are cut onto the track shoe longbar 106 using the laser cutter 126. For this purpose, the laser cutter 126 may be moved in any of the first, second and/or the third directions “A”, “B”, and “C” respectively. At step 408, the track shoe 102 is cut from the track shoe longbar 106 using the plasma cutter 130. The plasma cutter 130 may be accordingly moved in the first, second and/or the third directions “A”, “B”, and “C”.

The present disclosure provides a flexible and less time consuming method of manufacturing the track shoes 102. The method 400 allows for the manufacture of the track shoe of various design and geometries from the track shoe longbar 106. The cutting system 104 and method 400 also provides a reduction in the time and costs associated with the transportation of the track shoe longbars between various workstations by performing the cutting operations at one workstation. The cutting system 104 may be operated by a single operator, which may lower the labor cost associated with the track shoe manufacturing. This may provide a reduction in the overall lead time and cost associated with the manufacturing of the track shoes.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A method of manufacturing an undercarriage track shoe, the method comprising:
positioning a track shoe longbar at a workstation, the track shoe longbar having a sectional profile for a plurality of track shoes thereon, the sectional profile including a substantially planar base portion and at least one grouser extending from the base portion in a direction substantially perpendicular to the base portion;
engaging one end of the track shoe longbar in a first chuck and a second end of the track shoe longbar in a second chuck, wherein at least one of the first chuck and the second chuck is capable of movement in a first direction along a longitudinal axis, the first chuck and the second chuck being rotatable about the longitudinal axis, wherein the longitudinal axis is generally parallel to the first direction;
cutting at least one of a hole and a notch into the track shoe longbar using a laser cutter including moving the laser cutter in at least one of the first direction, a second direction, and a third direction during cutting, wherein the second direction is generally perpendicular to and coplanar with the first direction, and wherein the third direction is generally perpendicular to the first direction and the second direction; and
cutting a single track shoe from the track shoe longbar using a plasma cutter including rotating at least one of the first chuck and the second chuck relative to the plasma cutter during cutting, and moving the plasma cutter in at least one of the first direction, the second direction and the third direction.
